(19) United States
(12) Patent Application Publication
(10) Pub. No.: US 2007/0055795 A1
(43) Pub. Date: Mar. 8, 2007

(54) Data communication system and method with multi-channel power-down and wake-up

(75) Inventors: Jin-Ho Seo, Seoul (KR); Byoung-Woon Kim, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/486,931

(22) Filed: Jul. 14, 2006

(30) Foreign Application Priority Data
Aug. 12, 2005 (KR) 10-2005-0074128

(51) Int. Cl. G06F 3/00

(52) U.S. Cl. 710/15

(57) ABSTRACT

A data communication system includes a host configured to transmit a power-down identifier through a data channel and configured to drive a strobe channel. A client is coupled to the host through the data channel and the strobe channel, wherein the client is configured to drive the data channel to wake up the host; enter a power-down state in response to the power-down identifier received from the host; and wake up by detecting whether the strobe channel is driven by the host.

### CROSS-REFERENCE TO RELATED APPLICATIONS

This application claims priority under 35 U.S.C. § 119 to Korean Patent Application No. 10-2005-0074128 filed on Aug. 12, 2005, the contents of which are herein incorporated by reference in its entirety.

### BACKGROUND OF THE INVENTION

1. Field of the Invention

The present invention relates to data communication systems and methods, and more particularly to a data communication system and method for communicating data, for example large amounts of multimedia data, through at least one serial link using power-down and wake-up processes.

2. Description of the Related Art

In a data communication system having a host and a client system coupled through a serial link, a large amount of multimedia data can be transferred at high speed through the serial link, which includes a data channel through which the data is transferred. The host and client systems may be considered to be in a “normal operation” state or mode when they are transferring data, and when they are ready to do so.

The host and client systems connected to by serial link can be configured to enter a “power-down” state or mode when data communication is not executed for a considerable amount of time, thereby reducing power consumption. In order to subsequently communicate data, the host and client systems need to transition out of the power-down state and re-enter the normal operation state. This process can be referred to as a “wake-up” process, and the host and client systems can be referred to as being “woken-up” through this transition. Once the host and client systems are in a normal state they can again begin to perform normal data communication.

While there may be several approaches to accomplishing the foregoing power-down and wake-up processes, the well known Mobile Display Digital Interface (MDDI) standard provides one oft used approach (or protocol) that is applicable in many systems configured for transfers of large amounts of multimedia data.

According to the conventional power-down/wake-up process included in the MDDI standard, only the data channel is used for performing power-down/wake-up processes. Such systems, therefore, have certain limitations since the data channel is relied on for a variety of message traffic beyond that involved in the actual data transfers and approaches for power-down and wake-up for the client and the host are limited with such approaches, thus power conservation approaches are also limited.

### SUMMARY OF THE INVENTION

In accordance with some aspects of the present disclosure, provided is a data communication system that performs power-down/wake-up processes in accordance with a new protocol between a host and a client in the data communication system.

In accordance with other aspects of the present disclosure, provided is a method of operating a data communication for performing power-down/wake-up processes in accordance with a new protocol between a host and a client in a data communication system.

In some aspects of the present disclosure, provided is a data communication system that includes a host and a client. The host is configured to transmit a power-down identifier through a data channel and to drive a strobe channel. The client is coupled to the host through the data channel and the strobe channel and is configured to drive the data channel to wake up the host, enter a power-down state in response to the power-down identifier received from the host, and wake up by detecting whether the strobe channel is driven by the host.

The host may drive the strobe channel with a differential strobe signal to wake up the client and the client may drive the data channel with a differential wake-up signal to wake up the host. The client may enter the power-down state when the client detects the differential strobe signal through the strobe channel and the power-down identifier through the data channel.

The client may be configured to activate a strobe detection signal when the client detects the differential strobe signal, and may be configured to deactivate the strobe detection signal when the strobe channel is in a high-impedance state.

The host may be configured to generate a rewake-up mask signal to prevent the data channel and the strobe channel from being woken up for a predetermined time interval after the data channel and the strobe channel enter the power-down state.

The client may be configured to be woken up when the differential strobe signal is detected during the power-down state. And the host may be configured to be woken up when the differential wake-up signal is detected during the power-down state. The client may be configured to deactivate the differential wake-up signal when the client detects the differential strobe signal during a power-down state.

The host may include a strobe generation unit configured to provide a differential strobe signal to the strobe channel; a wake-up detection unit configured to generate a wake-up detection signal in response to a differential wake-up signal that is provided through the data channel from the client; and a data transmission unit configured to transmit a differential data signal through the data channel.

The client may include a strobe detection unit configured to generate a strobe detection signal in response to a differential strobe signal from the host; and a wake-up generation unit configured to provide a differential wake-up signal to the data channel.

As one example, the host may be coupled to a modem of a mobile terminal and the client may be coupled to an image display panel of the mobile terminal. As another example, the host may be coupled to an image sensor of a mobile terminal and the client may be coupled to a modem of the mobile terminal.

In accordance with other aspects of the disclosure, provided is a data communication system that includes a host and a client that are coupled to each other through a strobe channel and a data channel. The host may include a strobe generation unit configured to provide a differential strobe signal to the strobe channel, a wake-up detection unit configured to generate a wake-up detection signal when a differential wake-up signal is detected through the data channel, and a data transmission unit configured to transmit a differential data signal through the data channel. The client may include a strobe receiver unit for receiving the differential strobe signal through the strobe channel, a strobe detection unit configured to generate a strobe detection signal when the differential strobe signal is detected, a wake-up generation unit configured to provide the differential wake-up signal to the data channel, and a data receiver unit for receiving the differential data signal through the data channel.

The client may be configured to enter a power-down state when the client detects the differential strobe signal through the strobe channel, and detects a power-down identifier that is included in the differential data signal through the data channel. The client may be woken up when the strobe detection signal is activated during the power-down state. The host may be woken up when the wake-up detection signal is activated during the power-down state.

The client may be configured to activate the strobe detection signal when the client detects the differential strobe signal through the strobe channel and is configured to deactivate the strobe detection signal when the strobe channel is in a high-impedance state. The client may be further configured to turn off the strobe receiver unit and the data receiver unit when a predetermined time interval has elapsed after the strobe detection signal is deactivated during the power-down state.

The host may be configured to turn off the wake-up detection unit when a predetermined time interval has elapsed after the host provides the power-down identifier to the data channel. The host may also be configured to generate a rewake-up mask signal to prevent the data channel and the strobe channel from being woken up for a predetermined time interval after the data channel and the strobe channel enter the power-down state.

The client may be further configured to turn off the strobe detection unit when a predetermined time interval has elapsed after the strobe detection signal is activated during the power-down state. The client may be configured to turn off the strobe receiver unit and the data receiver unit when a predetermined time interval has elapsed after the strobe detection signal is activated during the power-down state. And the client may be configured to turn off the wake-up generation unit when the client detects the differential strobe signal during a power-down state.

The host may be configured to be woken up when the wake-up detection signal is activated during the power-down state. The host may be further configured to turn off the wake-up detection unit when a predetermined time interval has elapsed after the wake-up detection signal is activated during the power-down state.

As one example, the host may be coupled to a modem of a mobile terminal and the client may be coupled to an image display panel of the mobile terminal. In another example, the host may be coupled to an image sensor of a mobile terminal and the client may be coupled to a modem of the mobile terminal. The data differential data signal may be transmitted in a packet form of serial data, for example. In accordance with other aspects of the disclosure, a data communication system includes a first host, a first client, a second host and a second client. The first host transmits a first power-down identifier through a first data channel and drives a first strobe channel. The first client is coupled to the first host through the first data channel and the first strobe channel, and is configured to drive the first data channel to wake up the first host, enter a power-down state in response to the first power-down identifier received from the first host, and be woken up by detecting whether the first strobe channel is driven by the first host. The second host transmits a second power-down identifier through a second data channel, and drives a second strobe channel. The second client is coupled to the second host through the second data channel and the second strobe channel, and is configured to drive the second data channel to wake up the second host, enter the power-down mode in response to the second power-down identifier received from the second host, and to be woken up by detecting whether the second strobe channel is driven by the second host.

The first and second hosts may drive the first and second strobe channels with differential strobe signals, respectively. The first and second clients may drive the first and second data channels with differential wake-up signals to wake up the first and second hosts, respectively.

In accordance with other aspects of the present disclosure, a data communication system includes a first host and a first client that are coupled to each other through a first strobe channel and a first data channel, and a second host and a second client that are coupled to each other through a second strobe channel and a second data channel. Each of the first and second hosts includes a strobe generation unit configured to provide a differential strobe signal to the corresponding strobe channel, a wake-up detection unit configured to generate a wake-up detection signal when a differential wake-up signal is detected through the corresponding data channel, and a data transmission unit configured to transmit a differential data signal through the corresponding data channel. Each of the first and second clients includes a strobe receiver unit for receiving the differential strobe signal through the corresponding strobe channel, a strobe detection unit configured to generate a strobe detection signal when the differential strobe signal is detected, a wake-up generation unit configured to provide the differential wake-up signal to the corresponding data channel, and a data receiver unit for receiving the differential data signal through the corresponding data channel.

The first client may be configured to enter a power-down state upon detection of a first differential strobe signal received through the first strobe channel and a first power-down identifier that is included in a first differential data signal received through the first data channel. The second client may be configured to enter a power-down state upon detection of a second differential strobe signal received through the second strobe channel and a second power-down identifier that is included in a second differential data signal received through the second data channel.

Each of the first and second clients may be woken up when the differential strobe signal is detected during the power-down state. Each of the first and second hosts may be woken up when the differential strobe signal is detected during the power-down state.

In accordance with other aspects of the present disclosure, provided is a method of operating a data communication system including a host and a client that are coupled to each other through a strobe channel and a data channel. The method includes transitioning the client into a power-down mode by transmitting a power-down identifier from the host to the client through the data channel, waking up the client in the power-down mode by causing the host to drive the strobe channel, and waking up the host in the power-down state by causing the client to drive the data channel.

In the above method, the host may drive the strobe channel with a differential strobe signal. The client may drive the data channel with a differential wake-up signal to wake up the host. The method may further include detecting the differential strobe signal through the strobe channel by the client and transitioning the client into the power-down state in response to the detected differential strobe signal. Waking up the client may include detecting the differential strobe signal in the client and waking up the client in response to the detected differential strobe signal.

The method of operating the data communication system may further include generating a rewake-up mask signal in the host to prevent the data channel and the strobe channel from being woken up for a predetermined time interval after the data channel and the strobe channel enter the power-down mode. Waking up the host may include detecting the differential wake-up signal from the client and waking up the host in response to the detected differential wake-up signal.

In accordance with other aspects of the present disclosure, the above data communication systems may be used to unilaterally or bilaterally send and receive a large amount of multimedia data at a high speed.

### BRIEF DESCRIPTION OF THE DRAWINGS

The objects, features and advantages of the invention will be apparent from the more particular description of the preferred embodiments below, as illustrated in the accompanying drawings, in which like reference characters refer to the same parts throughout the different views. The drawings are not necessarily to scale, emphasis instead being placed on illustrating the principles of the disclosure, wherein:

FIG. 1 is a block diagram illustrating a client, a host and a serial link in a data communication system, according to an exemplary embodiment of the present disclosure;

FIG. 2 is a timing diagram illustrating an embodiment of a process for transitioning to a power-down state using serial link communications between the host and the client of FIG. 1;

FIG. 3 is a timing diagram illustrating an embodiment of another process for transitioning to a power-down state using serial link communications between the host and the client of FIG. 1;

FIG. 4 is a timing diagram illustrating an embodiment of a wake-up process for transitioning the host of FIG. 1 from a power-down state to a normal operation state;

FIG. 5 is a timing diagram illustrating an embodiment of another wake-up process for transitioning the host of FIG. 1 from a power-down state to a normal operation state;

FIG. 6 is a timing diagram illustrating an embodiment of a wake-up process for transitioning the client of FIG. 1 from a power-down state to a normal operation state;

FIG. 7 is a timing diagram illustrating an embodiment of another wake-up process for transitioning the client of FIG. 1 from a power-down state to a normal operation state;

FIG. 8 is a block diagram illustrating a client, a host and a serial link in a data communication system, according to another embodiment of the present disclosure;

FIG. 9 is a block diagram illustrating a client, a host and a serial link in a data communication system, according to still another embodiment of the present disclosure;

FIG. 10 is an embodiment of a block diagram illustrating a data communication system for unilateral communication from a host to a client; and

FIG. 11 is an embodiment of a block diagram illustrating a data communication system for bilateral communication between a host and a client.

### DESCRIPTION OF THE EMBODIMENTS

Disclosed herein are exemplary embodiments of data communication systems and methods that enable power-down and wake-up between at least one host and at least one client that communicate over at least one serial link having a strobe channel and a data channel. Specific structural and functional details disclosed herein are merely representative, for purposes of illustrating or teaching certain aspects or principles of the present invention. However, as will be appreciated by those skilled in the art, the present invention may be embodied in many alternate forms and should not be construed as limited to the exemplary embodiments set forth herein.

Accordingly, while the invention lends itself to various modifications and alternative forms, specific embodiments thereof are shown by way of example in the drawings, and such embodiments will herein be described in detail. It should be understood, however, that there is no intent to limit the invention to the particular forms disclosed, but on the contrary, the invention is to cover all modifications, equivalents, and alternatives falling within the spirit and scope of the disclosure. In the drawings, unless otherwise noted, like numbers refer to like elements throughout the description of the figures.

It will be understood that, although the terms first, second, etc. may be used herein to describe various elements, these elements should not be limited by these terms. These terms are used to distinguish one element from another, but not to imply a required sequence of elements. For example, a first element could be termed a second element, and, similarly, a second element could be termed a first element. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined herein, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be understood that the words “mode” and “state,” as used herein, have the same meaning unless otherwise indicated.

In the illustrative embodiments herein, a data communication system comprises a host system and a client system coupled together by at least on serial communication link. The host system is configured to transmit data to the client system, wherein such data may be large amounts of multimedia data. The host and client may be subsystems of a larger system or independent systems, or may be independent systems. For example, an image sensor of a mobile phone may be a host, while an image display panel of the mobile phone, such as a liquid crystal display (LCD) panel, may be a client.

Hereinafter, a host system, or an Input/Output (I/O) host, may be referred to as a “host.” In the same way, a client system, or an I/O client, may be referred to as a “client.” Repeated description for the same or similar elements will be omitted to avoid redundancy.

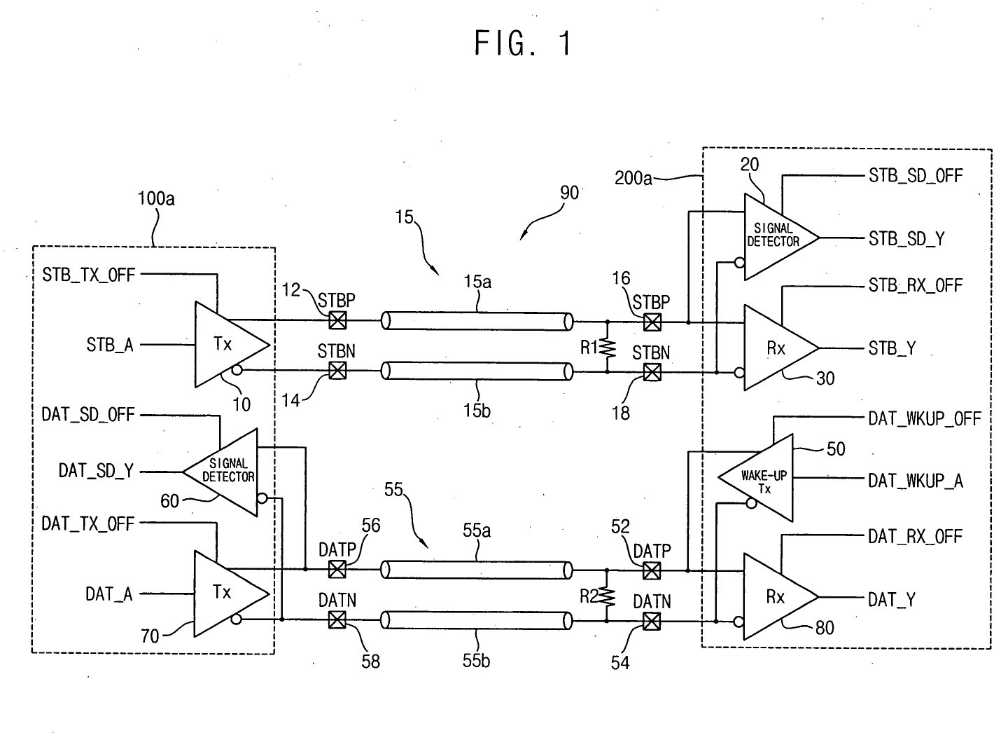

FIG. 1 is a block diagram illustrating one embodiment of a data communication system including a host 100a, a client 200a, and a serial link 90. The serial link 90 includes a strobe channel 15 and a data channel 55. In this embodiment, the strobe channel 15 includes strobe connectors 12, 14, 16 and 18, and first and second transmission lines 15a and 15b, respectively, which form a differential pair of transmission lines. A strobe signal is transmitted through the differential pair of transmission lines 15a, 15b as a differential signal, and is not significantly influenced by channel noise. In this embodiment, the data channel 55 includes data connectors 56, 58, 52 and 54, and third and fourth transmission lines 55a and 55b, respectively, which form a differential pair of transmission lines. A data signal is transmitted through the differential pair of transmission lines as a differential signal.

The host 100a includes a strobe transmission unit 10, a wake-up detection unit 60, and a data transmission unit 70. The client 200a includes a strobe receiver unit 30, a strobe detection unit 20, a wake-up generation unit 50, and a data receiver unit 80. The strobe transmission unit 10 of the host 100a transforms a strobe signal STB_A into a differential strobe signal, comprising STBP and STBN, and sends the differential strobe signal to the strobe receiver unit 30 of client 200a through the first and second transmission lines 15a and 15b.

The data transmission unit 70 of the host 100a transfers data from the host 100a to the client 200a via data channel 55 when in a normal operation state. In this embodiment, the data transmission unit transforms a data signal DAT_A into a differential data signal, comprising DATP and DATN, and sends the differential data signal to the data receiver unit 80 of client 200a through the third and fourth transmission lines 55a and 55b.

To enter a power-down state, the data transmission unit 70 of the host 100a sends a predetermined power-down identifier through data channel 55 to launch a transition to a power-down state of the client. When the client does not have its own clock, the client may generate an internal clock based on the strobe signal. The strobe detection unit 20 of the client 200a detects the differential strobe signal transmitted from the host 100a and outputs a strobe detection signal STB_Y. The strobe detection unit 20 may be turned on and off in response to a strobe-detection-unit control signal STB_SD_OFF. For example, the strobe detection unit 20 may be turned on when a strobe-detection-unit control signal STB_SD_OFF is in logic high state and may be turned off when the strobe-detection-unit control signal STB_SD_OFF is in logic low state. In other embodiments, the strobe detection unit 20 may be turned off when the strobe-detection-unit control signal STB_SD_OFF is in logic high state and may be turned on when the strobe-detection-unit control signal STB_SD_OFF is in logic low state.

The wake-up generation unit 50 of the client 200a transforms a wake-up signal DAT_WKUP_A into a differential wake-up signal and sends the wake-up signal to the wake-up detection unit 60 of the host 100a through the third and fourth transmission lines 55a and 55b. When the host 100a is in a power-down state, it is woken-up by the client 200a driving the data channel 55 with the differential wake-up signal. Here, “wake-up” means to transition from the power-down state to the normal operation state.

The wake-up generation unit 50 of client 200a is turned on and off in response to a wake-up-generation-unit control signal DAT_WKUP_OFF. For example, the wake-up generation unit 50 may be turned on when the wake-up-generation-unit control signal DAT_WKUP_OFF is in logic high state and turned off when the wake-up-generation-unit control signal DAT_WKUP_OFF is in logic low state. In other embodiments, the wake-up generation unit 50 may be turned off when the wake-up-generation-unit control signal DAT_WKUP_OFF is in logic high state and turned off when the wake-up-generation-unit control signal DAT_WKUP_OFF is in logic low state.

The wake-up detection unit 60 of the host 100a detects the differential wake-up signal and, in response thereto, outputs a wake-up detection signal DAT_SD_Y. The wake-up detection unit 60 is turned on and off in response to a wake-up-detection-unit control signal DAT_SD_OFF. For example, the wake-up detection unit 60 may be turned off when the wake-up-detection-unit control signal DAT_SD_OFF is in logic high state and may be turned on when the wake-up-detection-unit control signal DAT_SD_OFF is in logic low state. In other embodiments, the wake-up detection unit 60 may be turned on when the wake-up-detection-unit control signal DAT_SD_OFF is in logic high state and may be turned off when the wake-up-detection-unit control signal DAT_SD_OFF is in logic low state.

In another exemplary embodiment, an amount of data communication may be increased by enlarging the data channel between a host and a client. For example, a second data channel could be added between the host 100a and the client 200a of FIG. 1. The added second data channel may share the wake-up detection unit 60 and the wake-up generation unit 50 with the original data channel 55.

Hereinafter, a more detailed presentation of methods for host-initiated power-down, host-initiated wake-up and client-initiated wake-up will be described within the context of the exemplary embodiments provided herein. In a normal operation state, a strobe channel may be driven by a differential strobe signal and a data channel may be driven by a differential data signal, as briefly discussed above. The differential data signals may be transmitted in packet form.

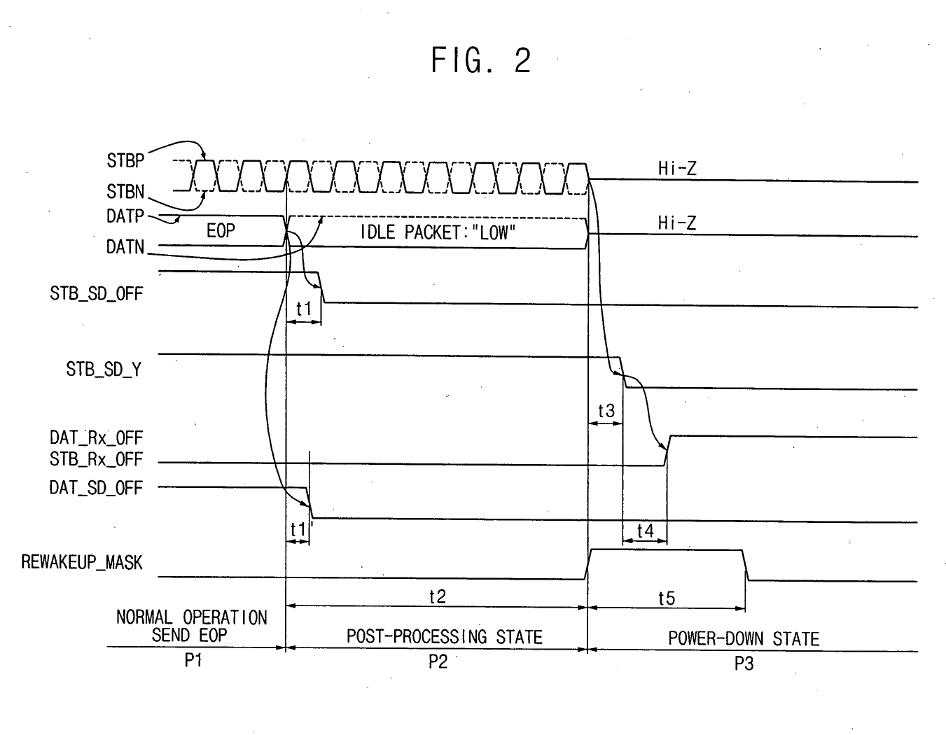

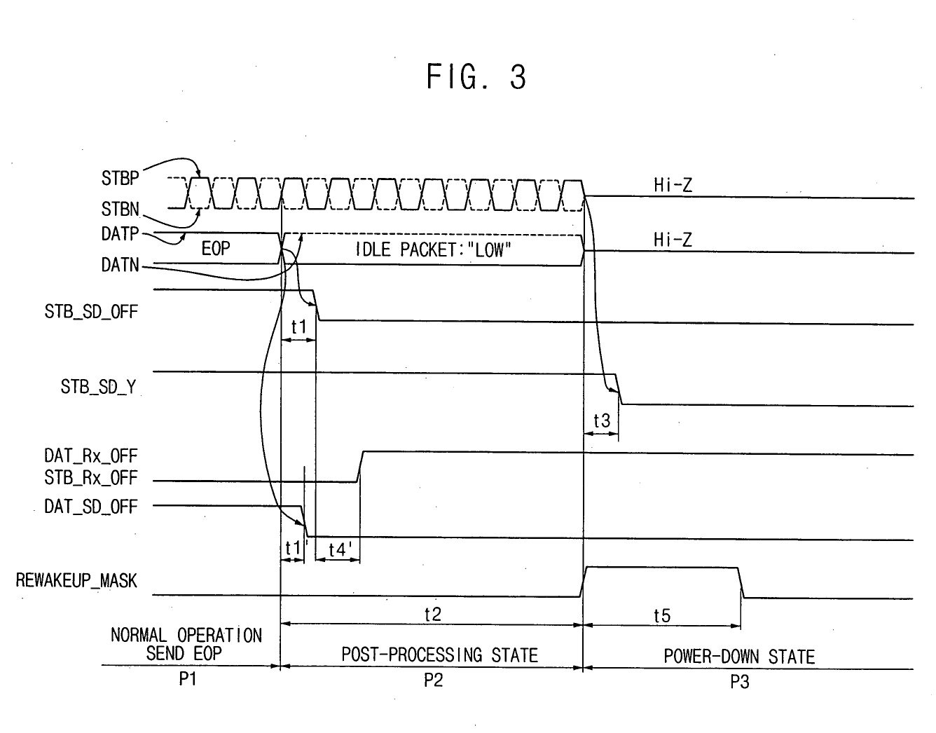

FIGS. 2 and 3 are timing diagrams illustrating embodiments of processes for entering a power-down state using a serial link between a host and a client, such as serial link 90, host 100a and client 200a of FIG. 1, as examples. The timing diagrams will be described with respect to the elements of FIG. 1 for illustrative purposes.

Referring to FIG. 2, while the strobe channel 15 is driven by the differential strobe signal, comprising STBP and STBN, the data transmission unit 70 of the host 100a transmits a predetermined power-down identifier through the data channel 55. This interval is shown as “P1” (i.e., the “Normal Operation Send EOP” state) in the timing diagrams of FIGS. 2 and 3. The power-down identifier may be a packet data signal including information on power-down, an end-of-packet (EOP) signal, and so on. Within a time interval t1 after the client 200a detects the power-down identifier, the strobe-detection-unit control signal STB_SD_OFF is transitioned to logic low level and the strobe detection unit 20 is turned on.

The host 100a transitions the wake-up-detection-unit control signal DAT_SD_OFF to a logic low level when a time interval t1′ is elapsed after transmission of the EOP signal. The wake-up detection unit 60 is turned on in response to a falling edge of the wake-up-detection-unit control signal DAT_SD_OFF. Although the time interval t1′ is shown as being shorter than the time interval t1 in FIGS. 2 and 3, the time interval t1′ may be longer than the time interval t1 in other embodiments.

The data transmission unit 70 of the host 100a maintains the data channel 55 in logic low (or high) state by transmitting an idle packet during a time interval t2, after transmission of the power-down identifier. This interval t2 is designated as “P2” (i.e., the “Post-Processing State”) in the timing diagrams of FIGS. 2 and 3. During the Post-Processing State, the client executes overall processes necessary for entering a power-down state. For example, information on the current state of the client may be stored during post-processing state. The time interval t2 is determined based on the amount of tasks to be processed by the client, so may vary in different embodiments.

The strobe channel 15 is changed to a high impedance state (referred to as a “Hi-Z” state) after interval P2, thereby entering a power-down state. This interval is referred to as “P3” (i.e., the Power-Down State) in the timing diagrams of FIGS. 2 and 3.

The strobe detection unit 20 of client 200a remains turned on during the Post-Processing State (i.e., interval P2). But when a time interval t3 is elapsed after the strobe channel 15 is changed to the Hi-Z state, the strobe detection unit 20, which is coupled to the strobe channel 15, detects the Hi-Z state on the strobe channel, and the strobe detection signal STB_SD_Y output by the strobe detection unit 20 is transitioned from logic high level to logic low level.

Within a time interval t4 after detection of Hi-Z state of the strobe channel 15, in response to the falling edge of the strobe detection signal STB_SD_Y, the strobe-receiver-unit control signal STB_RX_OFF and the data-receiver-unit control signal DAT_RX_OFF are transitioned from logic level low to logic high level. The strobe receiver unit 30 and data receiver unit 80, both of client 200a, are turned off in response to rising edges of the strobe-receiver-unit control signal STB_RX_OFF and the data-receiver-unit control signal DAT_RX_OFF.

That is, the strobe detection unit 20 of client 200a remains turned on during the Post-Processing State (i.e., interval P2). When the strobe detection unit 20 detects the Hi-Z state of the strobe channel 15, the logic state of the strobe detection signal STB_SD_Y may be transitioned to detect the termination of idle state of the data channel 55, thereby turning off the strobe receiver unit 30 and the data receiver unit 80 of client 200a, at about t4.

FIG. 3 provides another exemplary embodiment of a timing diagram of process for transitioning to the Power-Down State P3. FIG. 3 is substantially the same as FIG. 2, except in FIG. 3 the strobe-receiver-unit control signal STB_RX_OFF and the data-receiver-unit control signal DAT_RX_OFF may be transitioned to logic high level when a time interval t4′ is elapsed after the strobe detection unit 20 is turned on, thereby turning off the strobe receiver unit 30 and the data receiver unit 80 of client 200a.

In FIGS. 2 and 3, a point in time when the wake-up detection unit 60 of host 100a is turned on precedes a point in time when the strobe receiver unit 30 and data receiver unit 80 are turned off. However, the point in time when the wake-up detection unit 60 is turned on and the point in time when the strobe receiver unit 30 and the data receiver unit 80 are turned off may differ from the points shown in FIGS. 2 and 3. That is, the wake-up detection unit 60 may be turned on in advance and then the strobe receiver unit 30 and the data receiver unit 80 may be turned off. In other embodiments, the strobe receiver unit 30 and the data receiver unit 80 may be turned off in advance and then the wake-up detection unit 60 may be turned on.

In FIG. 2 and FIG. 3, when the data channel 55 enters the Power-Down State P3, after idle state of the data channel in P2 is ended, the host 100a may prevent the data channel 55 and the strobe channel 15 from being woken up for a predetermined amount of time after entering the Power-Down State, by generating a rewake-up mask signal REWAKEUP_MASK during a time interval t5. In other embodiments, the host 100a may not generate such a rewake-up mask signal REWAKEUP_MASK.

In the Power-Down State P3, the strobe detection unit 20 of the client 200a is turned on (for example, STB_SD_OFF=Low), the wake-up detection unit 60 is turned on (for example, DAT_SD_OFF=Low), and the strobe receiver unit 30 and the data receiver unit 80 are turned off. In addition, the strobe channel 15 and the data channel 55 are in high impedance states. The strobe and data channels may be forced to be in logic low state with the addition of a pull-down circuit, or in logic high state with the addition of a pull-up circuit, as will be appreciated by those skilled in the art.

According to the above exemplary embodiments, in the Power-Down State, only the wake-up detection unit 60 of the host 100a and the strobe detection unit 20 of the client 200a are turned on, so they consume electric power through a turn-on current. However, the strobe receiver unit 30 and the data receiver unit 80 of the client 200a are turned off, so they do not consume electric power in the Power-Down State. Thus, power consumption in the Power-Down State may be significantly reduced in comparison with power consumption in a Normal Operation State by implementing the wake-up detection unit 60 of the host 100a and the strobe detection unit 20 of the client 200a, wherein a turn-on current used to transition back to normal operation may be relatively low.

Once in a power-down state, a wake-up process must be performed to transition the data communication system to a Normal Operation State, where data transfer can occur. Wake-up processes, according to exemplary embodiments of the present invention, may be divided largely into a wake-up process by a host (i.e., a host-initiated wake-up), in which the host initiates wake-up of a client so that the host can transmit data to the client, and a wake-up process by a client (i.e., client-initiated wake-up), in which the client initiates wake-up of the host to request data transmission from the host. In some instances, a wake-up process collision may occur where the host-initiated wake-up and the client-initiated wake-up collide with each other. In such a case, one process may be given priority over the other, as an example. An embodiment of a process for resolving such collisions is provided herein below.

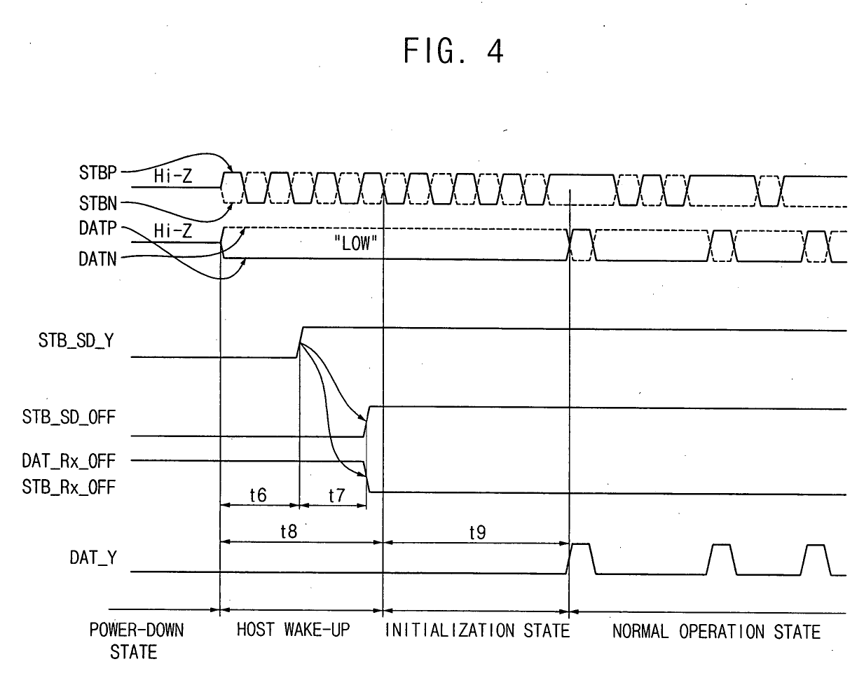

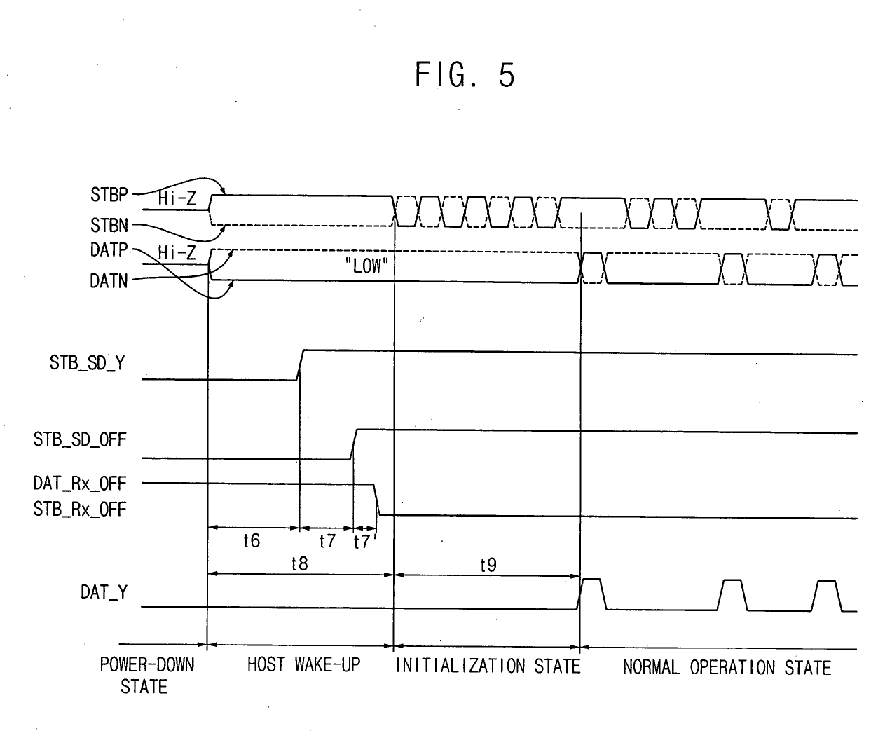

FIG. 4 and FIG. 5 are timing diagrams illustrating embodiments of wake-up processes that can be performed by a host, such as the host of FIG. 1. Using the host 100a and client 200a as examples, in the Power-Down State—the strobe detection unit 20 of the client 200a is turned on (for example, STB_SD_OFF=Low), see FIG. 4, the wake-up detection unit 60 is turned on (for example, DAT_SD_OFF=Low), see FIG. 5, and the strobe receiver unit 30 and the data receiver unit 80 of the client are turned off.

The strobe transmission unit 10 of the host 100a transforms the strobe signal STB_A into the differential strobe signal, again, STBP and STBN, to drive the strobe channel 15, and the strobe detection unit 20 of the client 200a detects the differential strobe signal. That is, a strobe detection signal STB_SD_Y of the client is activated (or transitioned) from logic low level to logic high level when a time interval t6 is elapsed after the host begins to drive the strobe channel 15 with the differential strobe signal. A strobe-detection-unit control signal STB_SD_OFF of the client is activated to logic high level to turn off the strobe detection unit 20 after a time interval t7, which is in response to a rising edge of the strobe detection signal STB_SD_Y in this embodiment.

In addition, after a time interval t7, and in response to the rising edge of the strobe detection signal STB_SD_Y, the strobe-receiver-unit control signal STB_RX_OFF and the data-receiver-unit control signal DAT_RX_OFF are transitioned to logic low level to turn on the strobe receiver unit 30 of the client and the data receiver unit 80 of the client 200a. As illustrated in FIG. 5, the strobe receiver unit 30 and the data receiver unit 80 of the client 200a may be implemented to remain off when a time interval t7′ has elapsed after the strobe detection unit 20 of the client is turned off.

A Host Wake-Up section of the timing diagrams of FIGS. 4 and 5 corresponds to a time interval t8, which may be determined based on the configuration of the host 100a. The differential strobe signal, comprising STBP and STBN, may be toggled during the Host Wake-Up interval, as shown in FIG. 4, or may not be toggled during the Host Wake-Up interval, as shown in FIG. 5.

Since the data channel 55 is woken-up after the host 100a is woken-up, the host is ready to send data and the client is ready to receive the data when the data channel 55 comes up (or is woken-up). Here, the data channel is woken-up when it is ready to support communications between the host and the client, e.g., when it is not in a Hi-Z state.

Using a toggling strobe signal STB_Y, the client 200a generates an internal clock during an Initialization State corresponding to a time interval t9. Subsequently, the client then enters a Normal Operation State. As illustrated in FIG. 4, in the Normal Operation State, differential strobe signals STBP and STBN may toggle while the data signal DAT_Y toggles and may not toggle while the data signal DAT_Y does not toggle.

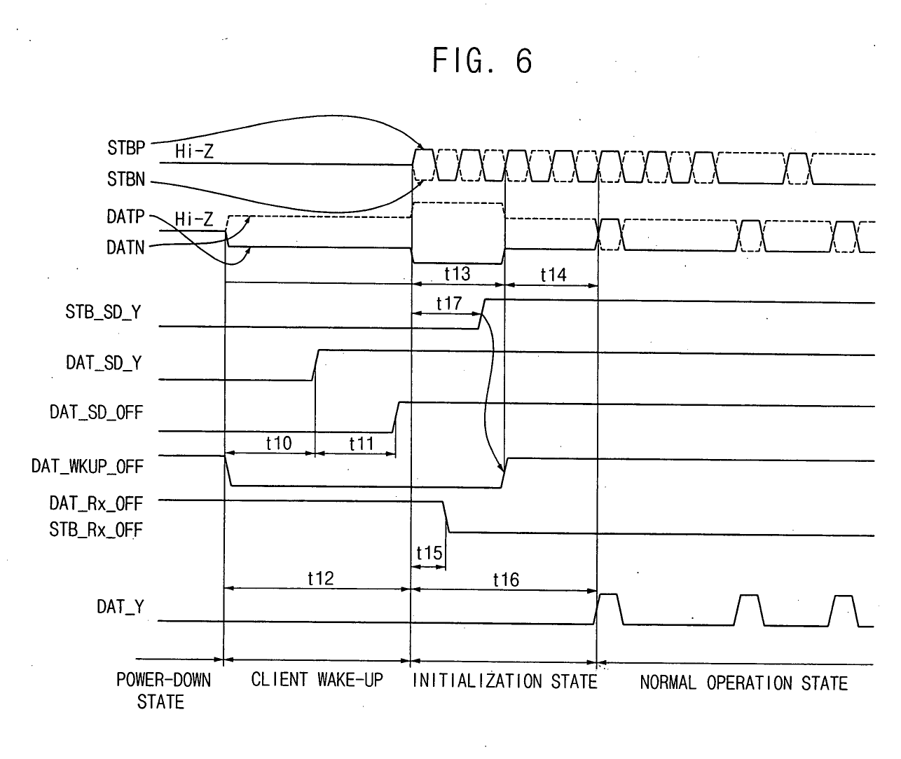

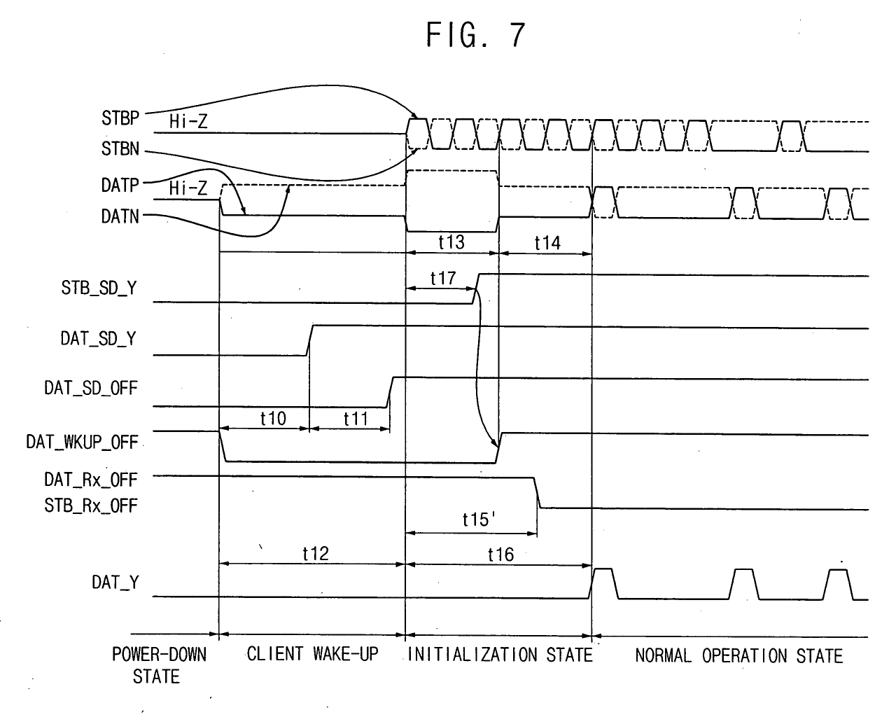

FIGS. 6 and 7 are timing diagrams illustrating embodiments of wake-up processes that can be used to wake up a client, such as client 200a of FIG. 1. A client wake-up process may be initiated by the client (i.e., a client-initiated wake-up process) or by the host (i.e., a host-initiated process). Using host 100a and client 200a as examples, in the case of a client-initiated wake-up process, the wake-up generation unit 50 of the client 200a transforms the wake-up signal DAT_WKUP_A into a differential wake-up signal to drive the data channel 55, and the wake-up detection unit 60 of the host 100a detects the differential wake-up signal through the data channel and, in response, wakes up the host.

In the Power-Down State, the strobe detection unit 20 of the client 200a is turned on (for example, STB_SD_OFF=Low), the wake-up detection unit 60 of the host 100a is turned on (for example, DAT_SD_OFF=Low), and the strobe receiver unit 30 and the data receiver unit 80, both of the client 200a, are turned off.

More particularly, the wake-up generation unit 50 of the client 200a is turned on in advance (for example, DAT_WKUP_OFF=Low), and then the wake-up generation unit 50 drives the data channel 55 with the differential wake-up signal. The wake-up detection unit 60 of the host detects the differential wake-up signal and activates (or transitions) the wake-up detection signal DAT_SD_Y from logic low level to logic high level when a time interval t10 is elapsed after the wake-up generation unit 50 of the client 200a is turned on.

When a time interval t11 is elapsed after the wake-up detection signal DAT_SD_Y is activated to logic high level, the host 100a transitions the level of the wake-up-detection-unit control signal DAT_SD_OFF to logic high level and turns off the wake-up detection unit 60 of the host 100a.

During a time interval t12, which may be predetermined, the wake-up generation unit 50 of the client is turned on and then the wake-up detection unit 60 of the host is turned off. The time interval t12 may be changed depending on configuration of the host/client system. The wake-up generation unit 50 of the client 200a drives the data channel 55 during a Client Wake-Up section of the timing diagram corresponding to the time interval t12.

Following the Client Wake-Up portion of the timing diagram, there is an Initialization State, which has a time interval of t16. After the Initialization State, the client 200a enters a Normal Operation State, where it can receive data transferred from the host 100a.

During the time interval t16, the host 100a toggles the strobe signal STB_A during the time interval t13 of the Initialization State and drives the strobe channel 15 with the differential strobe signal and the data channel with the differential data signal, i.e., STBP and STBN. Therefore, a signal on the data channel 55 can be doubled during the time interval of the Initialization State, since the host 100a and the client 200a simultaneously drive the data channel 55.

When the host 100a drives the strobe channel 15 with the differential strobe signal by toggling the strobe signal STB_A, the strobe detection unit 20 of the client 200a detects the differential strobe signal from the host 100a. More particularly, when a time interval t17 has elapsed after the host 100a drives the strobe channel 15 with the differential strobe signal, the strobe detection signal STB_SD_Y of the client 200a is transitioned from logic low level to logic high level. The time interval t17 is smaller than the time interval t13, in this embodiment.

In response to a rising edge of the strobe detection signal STB_SD_Y, the wake-up-generation-unit control signal DAT_WKUP_OFF of the client 200a is transitioned to logic high level to turn off the wake-up generation unit 50, and only the host 100a drives the data channel 55 during a time interval t14. That is, the host begins to control wake-up process.

When, through the differential data signal from the host 100a, the client 200a detects that the data channel 55 is driven, the client turns on the strobe receiver unit 30 (for example, STB_RX_OFF=Low) and turns on the data receiver unit 80 (for example, DAY_RX_OFF=Low) within a time interval t15. The time interval is smaller than the time interval t16, in this embodiment.

FIG. 7 is an illustrative timing diagram for an embodiment of a host-initiated wake-up process of the client. As illustrated in FIG. 7, after the wake-up generation unit 50 of the client 200a is turned off, the strobe receiver unit 30 may be turned on (for example, STB_RX_OFF=Low), and the data receiver unit 80 of the client may be turned on (for example, DAY_RX_OFF=Low) at a time interval t15′. Unlike interval t15 in FIG. 6, in FIG. 7, t15′ may be longer than t13. As in FIG. 6, the Initialization State corresponds to the time interval t16. In the Normal Operation State, the data transmission unit 70 of the host 100a drives the data channel 55 with the differential data signal. The wake-up generation unit 50 of the client 200a may have the same configuration as the strobe transmission unit 10 or the data transmission unit 70 of the host 100a, and may be implemented with a simple form of a current source.

A collision of concurrent wake-up requests occurs between the host and the client when the strobe detection unit 20 of the client coupled to the strobe channel 15 detects the differential strobe signal, and simultaneously the wake-up detection unit 60 of the host coupled to the data channel 55 detects the differential wake-up signal. For example, if the strobe detection unit 20 of client 200a detects a transition from logic low level to logic high level of the strobe detection signal STB_SD_Y while the client is performing a wake-up process, the client instantly delivers control of wake-up to the host 100a within a time interval t14 in FIGS. 6 and 7, and then the host-initiated wake-up process is performed, as described above.

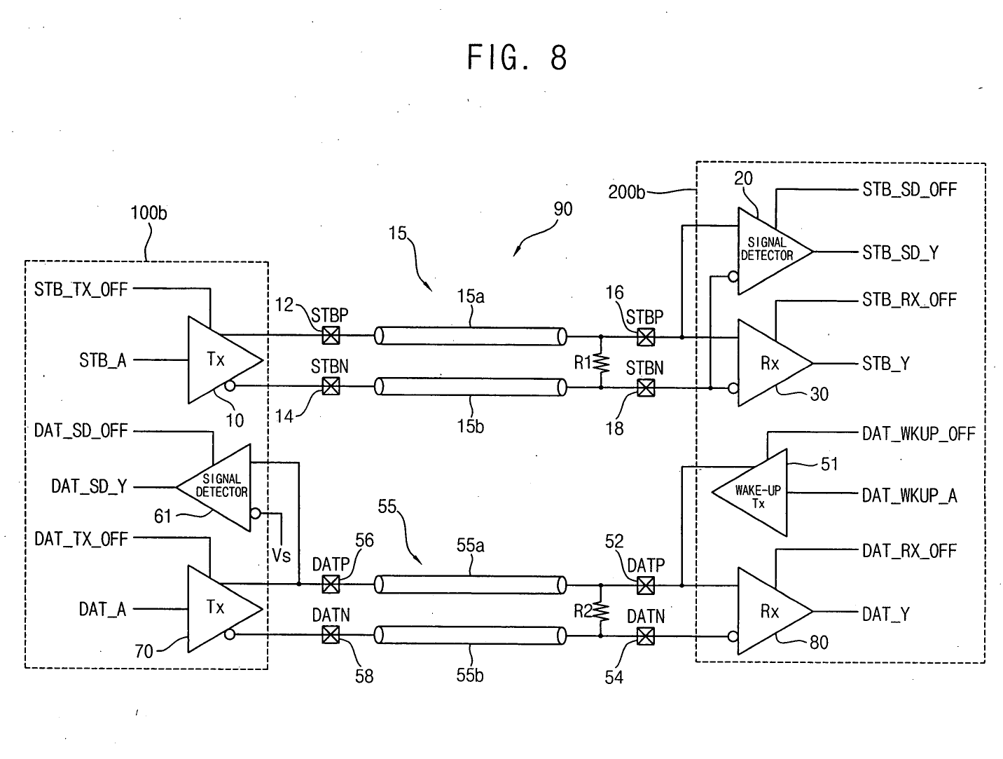

FIG. 8 is a block diagram of another embodiment of a data communication system that comprises a host 100b, a client 200b, and serial link 90. The elements of the communication system of FIG. 8 are similar to those of FIG. 1, except for the change in the client to a wake-up generation unit 51, to form the client 200b, and the change in the host to a wake-up detection unit 61, to form the host 100b.

Referring to FIG. 8, the wake-up generation unit 51 of the client does not transform the wake-up signal DAT_WKUP_A into a differential signal, but it does transmit the wake-up signal DAT_WKUP_A over transmission line 55a in this embodiment. The wake-up detection unit 61 of the host compares the wake-up signal DAT_WKUP_A, which is received through the transmission line 55a, with a reference voltage Vs to generate the wake-up detection signal. For example, the wake-up detection signal may be generated when the level of the wake-up signal DAT_WKUP_A is higher than the level of the reference voltage Vs and vice versa.

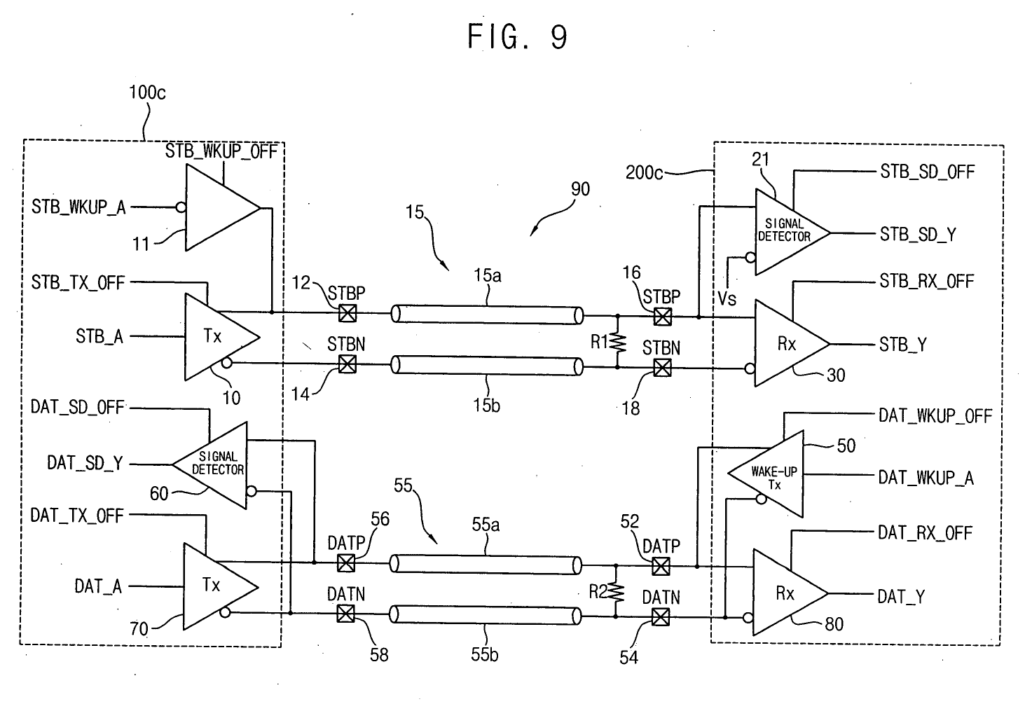

FIG. 9 provides another embodiment of a data communication system in the form of a block diagram including a host 100c, a client 200c, and serial link 90. The elements of the data communication system of FIG. 9 are similar to those of FIG. 1, except for the addition of a wake-up generation unit 11 to the client, to form the client 200c, and the change in the host to a wake-up detection unit 21, to form the host 100c.

The wake-up generation unit 11 of host 100c is coupled to the strobe channel 15a. The wake-up generation unit 11 does not transform the wake-up signal STB_WKUP_A into a differential signal, but it does transmit the wake-up signal STB_WKUP_A over transmission line 15a, in this embodiment. The wake-up detection unit 21 of the client compares wake-up signal STB_WKUP_A, which is received through the transmission line 15a, with a reference voltage Vs to generate the wake-up detection signal. For example, the wake-up detection signal may be generated when the level of the wake-up signal STB_WKUP_A is higher than the level of the reference voltage Vs, and vice versa.

Although not shown in FIGS. 1, 8 and 9, according to other exemplary embodiments, the data communication system may variously include one or more of the wake-up generation unit 51 and the wake-up detection unit 21 of the client, and the wake-up generation unit 11 and the wake-up detection unit 61 of the host.

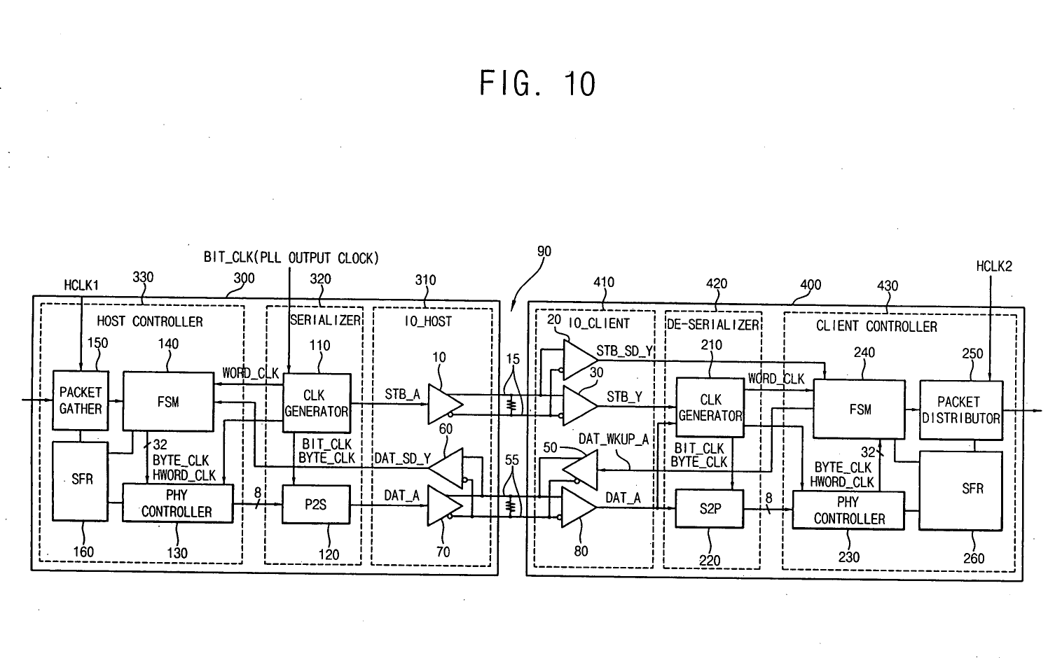

FIG. 10 is a block diagram illustrating an embodiment of a unilateral data communication system configured for unilateral communication from a host to a client. Elements from FIG. 1 are also present in FIG. 10, as being representative. A host 300 of the unilateral data communication system includes a host controller 330, a serializer 320, and an I/O host 310. In this embodiment, the I/O host 310 is substantially similar to the host 100a of FIG. 1. A client 400 of the unilateral data communication system includes a client controller 430, a deserializer 420, and an I/O client 410. In this embodiment, the I/O client 410 is substantially similar to the client 200a of FIG. 1. The hosts 100b and 100c and the clients 200b and 200c of FIG. 8 and FIG. 9, respectively, could alternatively be used in other embodiments.

In the embodiment of FIG. 10, the serializer 320 includes a first clock generator 110 and a parallel-to-serial (P2S) unit 120. The host controller 330 includes a physical layer controller 130, an internal FSM (finite state machine) controller 140, a packet gather 150 and a special function register (SFR) 160.

The first clock generator 110 generates clocks bit_clk, byte_clk, word_clk and hword_clk for serial communication. For example, in this embodiment, the clock bit_clk may have a frequency of 400 MHz, the clock byte_clk may have a frequency of 25 MHz corresponding to ⅛ frequency of the clock bit_clk, the clock word_clk may have a frequency of 12.5 MHZ corresponding to 1/32 frequency of the clock bit_clk, and the hword_clk may have a frequency of 25 MHz corresponding to 1/16 frequency of the clock bit_clk. In addition, the first clock generator 110 generates the strobe signal STB_A and provides the strobe signal STB_A to the strobe transmission unit 10.

The packet gather 150 receives commands, such as requests for data transmission and the data to be transmitted, and then outputs the commands and the data to the internal controller 140. The internal controller 140 packetizes the commands and the data to provide the packet to a physical layer controller 130, and controls data transmission to the client 400 in the normal operation state.

When the wake-up generation unit 60 of the client 400 transmits the wake-up signal DAT_WKUP_A to the host 300, while the host and the client are in the power-down mode, the wake-up detection signal DAT_SD_Y received by the wake-up detection unit 60 is provided to the internal controller 140, and the internal controller wakes-up the host controller 330. In addition, the internal FSM controller 140 controls the process of entering the Power-Down State shown in FIG. 2.

The physical layer controller 130 divides word-wise data packets into packet stream of byte-wise data packets in response to clocks byte_clk and hword_clk. The physical layer controller 130 adds the error correction code (ECC) and error detection code (EDC) to the packet stream and transmits the packet stream to the P2S 120.

The special function register 160 may include a configuration register and a plurality of status registers for storing data that is used by the packet gather 150, the internal controller 140 and the physical layer controller 130. The serializer 120 transforms 8-bit parallel data into a stream of 1-bit serial data in response to the clocks bit_clk and byte_clk to provide the data stream to the data transmission unit 70 of I/O host 310.

Continuing with FIG. 10, the client controller 430 includes a packet distributor 250, an internal FSM controller 240, a special function register SFR 260 and a physical layer controller 230. The deserializer 420 includes a second clock generator and a serial-to-parallel (S2P) unit 220.

The second clock generator 210 generates internal clocks bit_clk, byte_clk, word_clk, and hword_clk of the client deserializer 420, based on the strobe detection signal STB_SD_Y and the data signal DAY_Y output from the data receiver unit 80 of the IO client 410. For example, the second clock generator 210 may perform an Exclusive-OR (XOR) operation on the strobe detection signal STB_SD_Y and the data signal DAY_Y to generate the internal clocks. According to FIG. 10, the second clock generator 210 generates the internal clocks based on the strobe detection signal STB_SD_Y and the data signal DAY_Y. Alternatively, the second clock generator may generate the internal clocks by using only the strobe detection signal STB_SD Y.

The S2P unit 220 receives the stream of 1-bit serial data, transforms the stream of 1-bit serial data into word-wise 8-bit parallel data, and provides the 8-bit parallel data to the physical layer controller 230 in response to the internal clocks bit_clk and byte_clk. The special function register 260 may include a configuration register and a plurality of status registers for storing data that are used by the packet gather 250, the internal controller 240 and the physical layer controller 230.

The physical layer controller 230 divides byte-wise data packets into word-wise data packets in response to clocks byte_clk and hword_clk. The physical layer controller 130 removes the ECC and the EDC from the word-wise data packet, and transmits the data packets to the internal FSM controller 240. If an error occurs in the data packet, the physical layer controller 230 corrects the error or does not use the data packets including the error.

The internal FSM controller 240 extracts original data from the packet data, which are provided by the physical layer controller 130 in response to the internal clock word_clk, and provides the extracted data the packet distributor 250. The strobe detection signal STB_SD_Y, which is received from the strobe detection unit 20, is provided to the internal FSM controller 240. In addition, the internal controller 240 generates the wake-up signal DAT_WKUP_A to control the wake-up processes illustrated in FIGS. 6 and 7. The packet distributor 250 receives the data extracted from the internal controller 240 and transmits the received data to a function block (not shown) in the client, such as a liquid crystal display (LCD) panel, a modem block, etc.

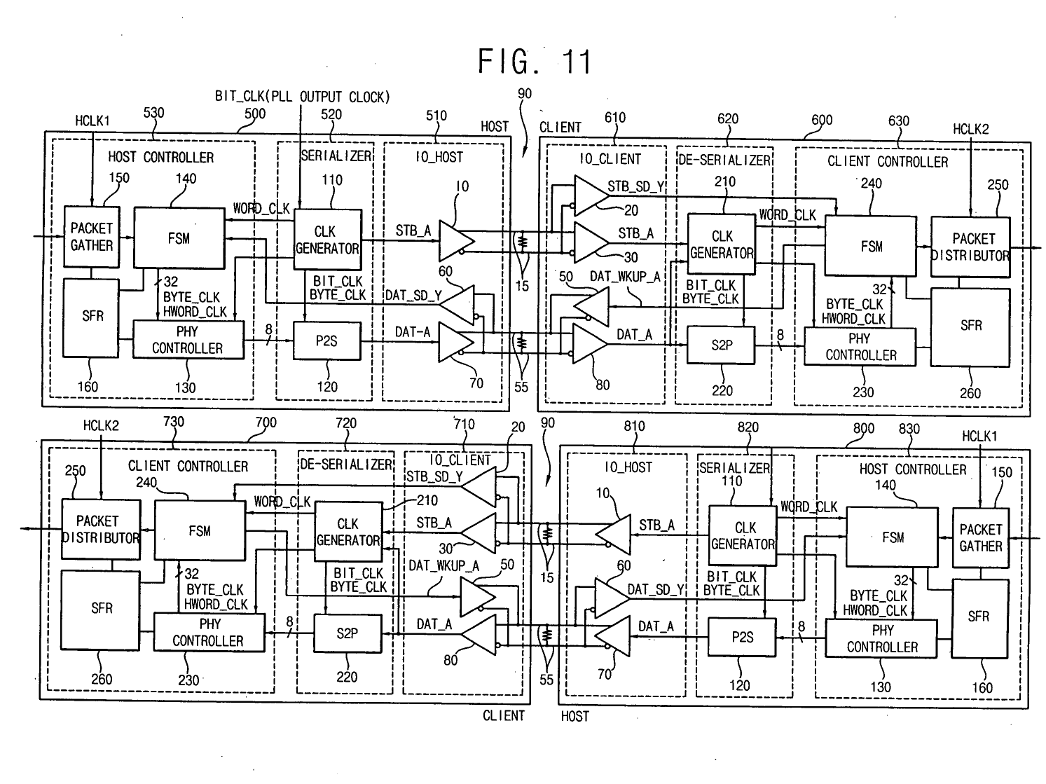

FIG. 11 is a block diagram illustrating an embodiment of a data communication system configured for bilateral communication between a host and a client. The bilateral data communication system includes a first host 500 coupled to a first client 600 and a second client 700 coupled to a second host 800. In this embodiment, the first host 500 and the second host 800 are substantially similar to the host 300 of FIG. 10 and the first client 600 and second client 700 are substantially similar to the client 400 of FIG. 10. And the serial links of FIG. 11 are substantially similar to serial link 90 of FIG. 10.

Like host 300 of FIG. 10, the first host 500 includes a host controller 530, a serializer 520 and an I/O host 510. And like client 400 of FIG. 10, the first client 600 includes a client controller 630, a deserializer 620 and an I/O client 610. Similarly, the second client 700 includes a client controller 730, a deserializer 720 and an I/O client 710. And the second host 800 includes a host controller 830, a serializer 820 and an I/O host 810. Inner blocks included in the first host 500, the first client 600, the second client 700 and the second host 800 are identical to those in FIG. 10.

As an example, the first host 500 and the second client 700 may be coupled to a modem of a mobile terminal, the first client 600 may be coupled to an image display panel, such as a LCD panel, and the second host 800 may be coupled to an image sensor of a camera module in the mobile terminal. In this case, a large amount of image data may be transmitted from the modem of the mobile terminal to the LCD panel of the first client 600 via the first host 500, and may be transmitted from the image sensor to the second client 700 via the second host 800.

Although the first clock generator 110 is illustrated in FIGS. 10 and 11 to be included in the serializer 120, in other embodiments the first clock generator 110 may be located external to the serializer or may be included in the internal controller 140. In addition, although the second clock generator 210 is illustrated in FIGS. 10 and 11 to be included in the deserializer 420, in other embodiments the second clock generator 210 may be located external to the deserializer, or may be included in the internal FSM controller 240.

In the above data communication system having a host and a client, the host may initiate the client to enter the power-down state by transmitting a predetermined power-down identifier and may wake-up the client in the power-down state by driving the strobe channel. In addition, the client may wake up the host by driving the data channel with a differential wake-up signal.

The data communication system, according to the exemplary embodiments, may be configured to unilaterally send and receive a large amount of multimedia data at a high speed. The data communication system, according to exemplary embodiments, may be configured to bilaterally send and receive the large amount of multimedia data at the high speed. In addition, the amount of data transmission may be increased by enlarging the data channel based on the data communication system.

Furthermore, if collision of concurrent wake-up requests occurs between the host and the client, the client may be configured to relinquish control of wake-up to the host, e.g., instantly, when the strobe detection signal from the host is transitioned to an active state. Therefore, using the strobe detection signal, the internal FSM controller of the host may initiate a host wake-up process when collision of concurrent wake-up requests occurs.

While the above embodiments and their advantages have been described in detail, it should be understood that various changes, substitutions and alterations may be made herein without departing from the scope of the invention. It is intended by the following claims to claim that which is literally described and all equivalents thereto, including all modifications and variations that fall within the scope of each claim.

What is claimed is:

1. A data communication system comprising:
a host configured to transmit a power-down identifier through a data channel and configured to drive a strobe channel; and
a client coupled to the host through the data channel and the strobe channel, wherein the client is configured to:
drive the data channel to wake up the host;
enter a power-down state in response to the power-down identifier received from the host; and
be woken up by detecting whether the strobe channel is driven by the host.

2. The data communication system of claim 1, wherein the host is configured to drive the strobe channel with a differential strobe signal.

3. The data communication system of claim 2, wherein the client is configured to drive the data channel with a differential wake-up signal to wake up the host.

4. The data communication system of claim 3, wherein the client is configured to enter the power-down state when the client detects the differential strobe signal through the strobe channel and the power-down identifier through the data channel.

5. The data communication system of claim 3, wherein the client is configured to activate a strobe detection signal when the client detects the differential strobe signal, and is configured to deactivate the strobe detection signal when the strobe channel is in a high-impedance state.

6. The data communication system of claim 3, wherein the host is configured to generate a rewake-up mask signal to prevent the data channel and the strobe channel from being woken up for a predetermined time interval after the data channel and the strobe channel enter the power-down state.

7. The data communication system of claim 3, wherein the client is configured to be woken up when the differential strobe signal is detected during the power-down state.

8. The data communication system of claim 3, wherein the host is configured to be woken up when the differential wake-up signal is detected during the power-down state.

9. The data communication system of claim 3, wherein the client is configured to deactivate the differential wake-up signal when the client detects the differential strobe signal during a power-down state.

10. The data communication system of claim 1, wherein the host includes:
a strobe generation unit configured to provide a differential strobe signal to the strobe channel;
a wake-up detection unit configured to generate a wake-up detection signal in response to a differential wake-up signal that is provided through the data channel from the client; and
a data transmission unit configured to transmit a differential data signal through the data channel.

11. The data communication system of claim 1, wherein the client includes:
a strobe detection unit configured to generate a strobe detection signal in response to a differential strobe signal from the host; and
a wake-up generation unit configured to provide a differential wake-up signal to the data channel.

12. The data communication system of claim 1, wherein the host is coupled to a modem of a mobile terminal and the client is coupled to an image display panel of the mobile terminal.

13. The data communication system of claim 1, wherein the host is coupled to an image sensor of a mobile terminal and the client is coupled to a modem of the mobile terminal.

14. A data communication system comprising a host and a client that are coupled to each other through a strobe channel and a data channel,
the host comprising:
a strobe generation unit configured to provide a differential strobe signal to the strobe channel;
a wake-up detection unit configured to generate a wake-up detection signal when a differential wake-up signal is detected through the data channel; and
a data transmission unit configured to transmit a differential data signal through the data channel; and
the client comprising:
a strobe receiver unit for receiving the differential strobe signal through the strobe channel;
a strobe detection unit configured to generate a strobe detection signal when the differential strobe signal is detected;
a wake-up generation unit configured to provide the differential wake-up signal to the data channel; and
a data receiver unit for receiving the differential data signal through the data channel.

15. The data communication system of claim 14, wherein the client is configured to enter a power-down state when the client detects the differential strobe signal through the strobe channel and a power-down identifier that is included in the differential data signal through the data channel.

16. The data communication system of claim 15, wherein the client is configured to activate the strobe detection signal when the client detects the differential strobe signal through the strobe channel and is configured to deactivate the strobe detection signal when the strobe channel is in a high-impedance state.

17. The data communication system of claim 16, wherein the client is further configured to turn off the strobe receiver unit and the data receiver unit when a predetermined time interval has elapsed after the strobe detection signal is deactivated during the power-down state.

18. The data communication system of claim 15, wherein the host is configured to turn off the wake-up detection unit when a predetermined time interval has elapsed after the host provides the power-down identifier to the data channel.

19. The data communication system of claim 15, wherein the host is configured to generate a rewake-up mask signal to prevent the data channel and the strobe channel from being woken up for a predetermined time interval after the data channel and the strobe channel enter the power-down state.

20. The data communication system of claim 15, wherein the client is configured to be woken up when the strobe detection signal is activated during the power-down state.

21. The data communication system of claim 20, wherein the client is further configured to turn off the strobe detection unit when a predetermined time interval has elapsed after the strobe detection signal is activated during the power-down state.

22. The data communication system of claim 20, wherein the client is configured to turn off the strobe receiver unit and the data receiver unit when a predetermined time interval has elapsed after the strobe detection signal is activated during the power-down state.

23. The data communication system of claim 15, wherein the host is configured to be woken up when the wake-up detection signal is activated during the power-down state.

24. The data communication system of claim 24, wherein the host is further configured to turn off the wake-up detection unit when a predetermined time interval has elapsed after the wake-up detection signal is activated during the power-down state.

25. The data communication system of claim 23, wherein the client is configured to turn off the wake-up generation unit when the client detects the differential strobe signal during a power-down state.

26. The data communication system of claim 15, wherein the host is coupled to a modem of a mobile terminal and the client is coupled to an image display panel of the mobile terminal.

27. The data communication system of claim 15, wherein the host is coupled to an image sensor of a mobile terminal and the client is coupled to a modem of the mobile terminal.

28. The data communication system of claim 15, wherein the differential data signal is transmitted in a packet form of serial data.

29. A data communication system comprising:
a first host configured to transmit a first power-down identifier through a first data channel and configured to drive a first strobe channel;
a first client coupled to the first host through the first data channel and the first strobe channel, the first client configured to drive the first data channel to wake up the first host, configured to enter a power-down state in response to the first power-down identifier received from the first host, and configured to be woken up by detecting whether the first strobe channel is driven by the first host;
a second host configured to transmit a second power-down identifier through a second data channel, and configured to drive a second strobe channel; and
a second client coupled to the second host through the second data channel and the second strobe channel, the second client configured to drive the second data channel to wake up the second host, configured to enter the power-down state in response to the second power-down identifier received from the second host, and configured to be woken up by detecting whether the second strobe channel is driven by the second host.

30. The data communication system of claim 29, wherein the first and second hosts are configured to drive the first and second strobe channels with differential strobe signals.

31. The data communication system of claim 30, wherein the first and second clients are configured to drive the first and second data channels with differential wake-up signals to wake up the first and second hosts.

32. A data communication system comprising a first host and a first client coupled together through a first strobe channel and a first data channel, and a second host and a second client coupled together through a second strobe channel and a second data channel,
each of the first and second hosts comprising:
a strobe generation unit configured to provide a differential strobe signal to the corresponding strobe channel;
a wake-up detection unit configured to generate a wake-up detection signal when a differential wake-up signal is detected through the corresponding data channel; and
a data transmission unit configured to transmit a differential data signal through the corresponding data channel; and
each of the first and second clients comprising:
a strobe receiver unit for receiving the differential strobe signal through the corresponding strobe channel;
a strobe detection unit configured to generate a strobe detection signal when the differential strobe signal is detected;
a wake-up generation unit configured to provide the differential wake-up signal to the corresponding data channel; and
a data receiver unit for receiving the differential data signal through the corresponding data channel.

33. The data communication system of claim 32, wherein the first client is configured to enter a power-down state upon detection of a first differential strobe signal received through the first strobe channel and a first power-down identifier that is included in a first differential data signal received through the first data channel.

34. The data communication system of claim 33, wherein the second client is configured to enter a power-down state upon detection of a second differential strobe signal received through the second strobe channel and a second power-down identifier that is included in a second differential data signal received through the second data channel.

35. The data communication system of claim 32, wherein each of the first and second clients is configured to be woken up when the differential strobe signal is detected during a power-down state.

36. The data communication system of claim 32, wherein each of the first and second hosts is configured to be woken up when the differential strobe signal is detected during a power-down state.

37. A method of operating a data communication system including a host and a client that are coupled to each other through a strobe channel and a data channel, the method comprising:
transitioning the client into a power-down state by transmitting a power-down identifier from the host to the client through the data channel;
waking up the client in the power-down state by causing the host to drive the strobe channel; and
waking up the host in the power-down state by causing the client to drive the data channel.

38. The method of claim 37, including the host driving the strobe channel with a differential strobe signal.

39. The method of claim 38, including the client driving the data channel with a differential wake-up signal to wake up the host.

40. The method of claim 39, wherein transitioning the client into a power-down state comprises:
detecting the differential strobe signal through the strobe channel by the client; and
initiating the client into the power-down state in response to the detected differential strobe signal.

41. The method of claim 38, wherein waking up the client comprises:
detecting the differential strobe signal from the host; and
waking up the client in response to the detected differential strobe signal.

42. The method of claim 37, further comprising:
transitioning each of the strobe channel and the data channel into a channel power down state; and
generating a rewake-up mask signal in the host to prevent the data channel and the strobe channel from being woken up for a predetermined time interval after the data channel and the strobe channel enter the channel power-down state.

43. The method of claim 39, wherein waking up the host comprises:
detecting the differential wake-up signal from the client; and
waking up the host in response to the detected differential wake-up signal.
